(19) United States
(12) Patent Application Publication
(10) Pub. No.: US 2005/0212309 A1
(43) Pub. Date: Sep. 29, 2005

(54) Door and window stop

(76) Inventor: Frank F.E. Mayer, Niederkirchen (DE)

Correspondence Address: FOLEY AND LARDNER;SUITE 500, 3000 K STREET NW, WASHINGTON, DC, 20007, US

(21) Appl. No.: 10/503,637

(22) PCT Filed: Jan. 24, 2003
(86) PCT No.: PCT/EP03/00707

§ 371 Date: Aug. 5, 2004

(30) Foreign Application Priority Data
Feb. 7, 2002 (DE) 202 01 887.3
Oct. 11, 2002 (DE) 102 47 515.6

(51) Int. Cl. E05C 17/54

(52) U.S. Cl. 292/343

(57) ABSTRACT

The invention relates to a stop for doors and windows. Said stop consists of an elastic rubber body with a high friction coefficient, which has a thicker round region tapering to an adjacent narrow tip region. According to the invention, the narrow tip region is curved inwards and the width of the body is slightly larger than the distance between the perpendicular case of a window and its frame, the thickness of said body being proportioned in such a way that it can stand on its edge. A stop of this type is versatile for doors and windows and can hold windows at various open angles.

The present invention relates to a novel stop for doors and windows.

Known stops intended for preventing doors from slamming, for example due to a draft, comprise wedges which are clamped under the doors or between the windows.

These stops have the disadvantage that they cannot be used for fixing windows. In the case of doors, this is possible, since the wedges can be fitted at the desired location between the floor and the door leaf, something which is not possible with these wedges in the case of windows.

The present invention has therefore set itself the object of providing a novel door and window stop which can be used in a much more versatile way than one according to the prior art, i.e. with which not only doors but also windows can be fixed in a large pivoting range and with which it is also possible to secure tilted windows.

This object is successfully achieved by a stop for doors and windows which comprises a rubber-elastic body with a high friction coefficient and has a thicker round region and an adjoining narrow region tapering to a tip, the region that tapers to a tip being drawn inward and the width of the body being slightly greater than the distance between the perpendicular cases of a window and its frame. The thickness of the body is dimensioned such that it can stand on its edges.

Such a stop can be used in a versatile manner on account of its configuration and its rubber-elastic properties.

It can be used transversely in relatively large gaps and on end in small gaps. In this case, the narrow continuation acts as a spring and the high friction coefficient ensures that it does not slip in gaps with parallel walls, so that it can also be used without touching a base line.

Various application possibilities are shown in the accompanying figures.

The shape of the body (in plan view) is preferably a segment cut out from a circle which passes in an S-shaped manner through the center of the circle and runs out tangentially toward the periphery. Therefore, if the S curve is symmetrical, two bodies of this type can be joined together to form a circle. The contour corresponds to the known Chinese symbol for Yin and Yang.

For normal window sizes and door gaps, a body width of approximately 8-12 cm, preferably 10 cm, has proven to be successful, corresponding to a circle radius of the uncut-out body of 4-6 cm.

This body can be readily compressed inward at the tip by about 3 cm. If the tip of the narrow-tapering part is placed on the floor, the spring deflection is about 1 cm, it being important to note that, on account of the high friction coefficient and the elasticity, the clamping effect occurs not only at the vertex point but also in front of and behind it. Therefore, the positioning under a window, for example, between the lower edge of the window and the windowsill, does not have to be exact.

The positioning is made easier by the stop having a thickness of approximately 1-2 cm. On account of its density and the position of its center of gravity, it is consequently stable.

A particularly good spring effect of the narrow continuation is achieved, while retaining high rupture stability, in the case of the circle radius specified above with a depth of the S-shaped cut of approximately 2-3 cm.

Silicone rubber (with particular preference EPDM of a Shore hardness of approximately 50 to 80) has proven to be particularly suitable for the production of the stop according to the invention.

This material combines high stability with a high friction coefficient, which is of great significance for the way in which it functions.

It is finally proposed to provide the thick region with a bore. Since, as mentioned above, two of the stops can be put together to form a circular disk, this achieves an esthetic effect, for example in its presentation; it should be pointed out that the parts may be differently colored; in addition to their function, the stops also have individually or else in groups a surprising playful effect.

If desired, large leaves of doors or casements of windows can of course also be fixed on both sides by means of two stops.

The present invention is explained in more detail on the basis of the accompanying figures, in which:

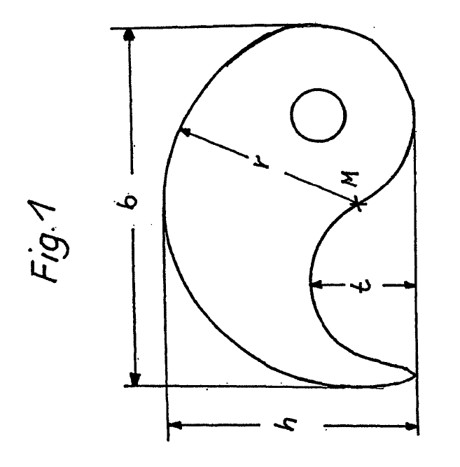

FIG. 1 shows a stop in plan view.

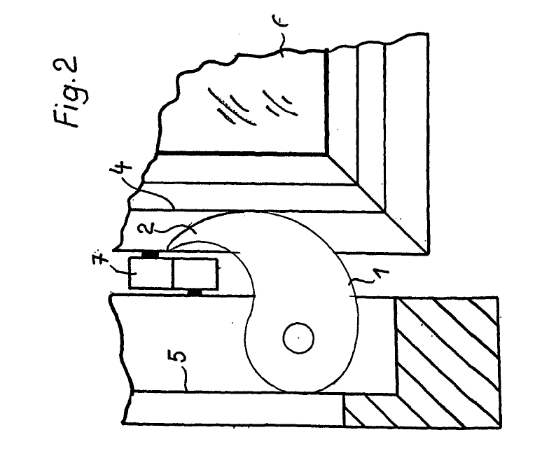

FIG. 2 shows it being used on an open window, between the frame parts.

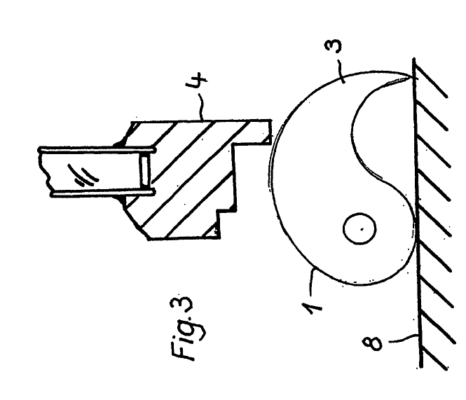

FIG. 3 shows the clamping of a window at the windowsill and

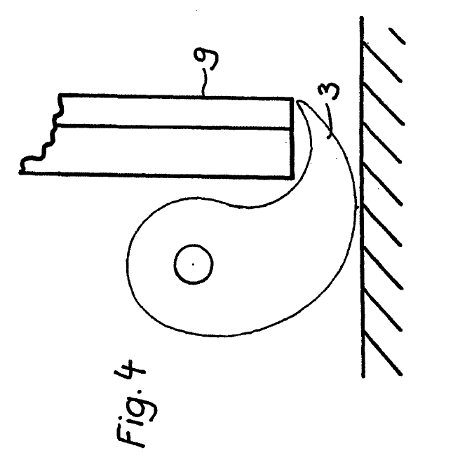

FIG. 4 shows the securing of a door.

FIG. 1 shows a stop 1 according to the invention. It has been cut out from a circle with the radius r about the center point M over an S-shaped curve k, the point of inflection of which is the center point m of the circle.

It consists of rubber-elastic plastic, preferably silicone rubber, and accordingly has a high friction coefficient. In order to be used in the case of customary window dimensions, the radius r is ˜5 cm and the depth of the S-shaped cut is ˜3 cm, so that a height h of approximately 6˜5 cm is obtained, with a width b equal to 2 r.

This produces a body with a thicker, round region 2, which is adjoined by a region 3 which tapers to a tip, is curved inward, is slender and consequently has good resilient properties.

The thicker region may be provided with a bore, which may serve as a lead-through for a rod or the like. The material of the stop is, in particular, EPDM of a Shore hardness of 50 to 80.

FIG. 2 illustrates the keeping open of an open window 6 between its inner frame 4 and its outer frame 5, the window 6 having been opened about its hinges 7 as far as the rabbet.

The stop can be clamped at any height between these; the spring effect of the narrow region 2 presses the stop against the two strips of the window 1; the high friction coefficient keeps it in this position, with the window being braced against the rabbet. In the case of tilted windows, the stop may be clamped in a similar way transversely or on end into the wedge-shaped gap between the outer frame and the inner frame.

FIG. 3 shows the stop 1 placed on a windowsill 8. If the window frame 4 is moved against the stop 1, the narrow region 3 is resiliently deflected inward after contact and the stop is pressed against the frame 4 from below and held by friction. In this way, it is possible for the first time to secure the window against slamming even in a “half” open position.

FIG. 4 shows the securing of a door 9. The stop has been pushed under the door leaf with its narrow region 3 that tapers to a tip.

This makes use of the wedge shape of this region 3.

The clamping effect is enhanced by the outer-lying center of gravity, which has the tendency to raise the region 3.

1. A stop for doors and windows with the following features:
a) the stop (1) comprises a rubber-elastic body with a high friction coefficient,
b) it has a thicker round region (2) and an adjoining narrow region (3) tapering to a tip,
c) the region (3) that tapers to a tip being drawn inward and
d) the width (b) of the body (1) being slightly greater than the distance between the perpendicular cases of a window and its frame and
e) the thickness of the body being dimensioned such that it can stand on its edges.

2. The stop as claimed in claim 1, characterized in that the body is a segment cut out from a circular disk, the cut being S-shaped, passing through the center point M of the circle and running out tangentially into the periphery of the circle.

3. The stop as claimed in claim 1, characterized in that the width (b) of the body is approximately 7-13 cm, preferably 10 cm, corresponding to a radius r of 3.5-6.5, preferably 5 cm.

4. The stop as claimed in claim 1, characterized in that the thickness of the body is approximately 1-2 cm.

5. The stop as claimed in claim 1, characterized in that the depth t of the S-shaped cut is approximately 2-3 cm.

6. The stop as claimed in claim 1, characterized in that the thick region (2) has a bore.

7. The stop as claimed in claim 1, characterized in that the body (1) consists of silicone rubber.

8. The stop as claimed in claim 1, characterized in that it consists of EPDM of a Shore hardness of approximately 50 to 80.
